(19) United States
(12) Patent Application Publication
(10) Pub. No.: US 2011/0260020 A1
(43) Pub. Date: Oct. 27, 2011

(54) JIGGLE SIGN

(76) Inventors: Jonathan Isserow, Basking Ridge, NJ (US); Laura Isserow, Basking Ridge, NJ (US)

(21) Appl. No.: 12/787,482

(22) Filed: May 26, 2010

Related U.S. Application Data
(60) Provisional application No. 61/326,267, filed on Apr. 21, 2010.

(51) Int. Cl. F16B 47/00; F16M 13/02; F16M 13/00

(52) U.S. Cl. 248/205.3; 248/309.1; 248/206.5

(57) ABSTRACT

Disclosed is a support device having a first support element. The first support element has a first surface and a second surface. The first support element connects to a second support element via an elongated holder. The elongated holder has a first and second ends that mount within the support elements. The first support element may be attached to a support surface, while the second support element may contain a message or may be shaped in form of an object.

### CLAIM OF PRIORITY

This application claims priority to U.S. Ser. No. 61/326,267 filed Apr. 21, 2010, the contents of which are fully incorporated herein by reference.

### FIELD OF THE INVENTION

The invention relates to decorative support frames.

### BACKGROUND OF THE INVENTION

The invention is a novel device intended to replace gift tags and gift cards, such as birthday cards, gift cards, etc, and could be a unique gift or gift accessory and could replace or complement a card on a gift. Gift cards and tags are traditionally given with gifts at parties and special occasions. Once given, they are typically thrown away by the receiver. Therefore, such ornaments are rarely noticed for longer than several moments and are usually disposed of together with any gift wrapping. The ornament could be a gift itself. With the present invention, a removable tag can be reapplied to a new surface, such as a refrigerator door. This helps keep the memories of the special date or event alive. The present invention utilizes a support structure that is predisposed to jiggling when agitated, emphasizing its eye catching appeal. The support frame could be used in the promotional aspects of the fridge magnet industry because of its unique appearance and motion.

The invention may have a cover over a combination of magnetic and adhesive surfaces that can be put on a cake box or placed on the cake topping. This device may be removed after the celebration and reattached to a refrigerator door or to another surface using the adhesive or magnetic surfaces. This way, the plaque will not be quickly discarded and will continue to impress its recipient. The flexible elongated holder may be attractive and imaginative. It can be attached at an angle, and retain its changed shape after being compressed or deformed.

Various implements are known in the art, but fail to address all of the problems solved by the invention described herein. One embodiment of this invention is illustrated in the accompanying drawings and will be described in more detail herein below.

### SUMMARY OF THE INVENTION

Disclosed is a support device having a first support element. The first support element has a first surface and a second surface. The first support element connects to a second support element via an elongated holder. The elongated holder has a first and second ends that mount within or over the support elements. The first support element may be attached to a support surface, while the second support element may contain a message or may be shaped in form of an object, or otherwise

Therefore, the present invention succeeds in conferring the following useful benefits and objectives, including others not mentioned.

It is an object of the present invention to provide an eye catching gift tag.

It is another object of the present invention to provide a gift tag that can be noticed for a long time.

Yet another object of the present invention is to provide an effective promotional sign.

Still another object of the present invention is to provide an attractive plaque for a gift.

Still another object of the present invention is to provide a whimsical refrigerator door ornament or decoration.

### BRIEF DESCRIPTION OF THE DRAWINGS

FIG. 1 is a perspective side view of the present invention, attached to the top of a gift. The second support element is shaped in form of a heart.

FIG. 2 is a side view, with the first support element attached to a fridge door.

FIG. 3 is an exploded side view of the present invention.

FIG. 4 is another preferred embodiment showing a second one elongated holder.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

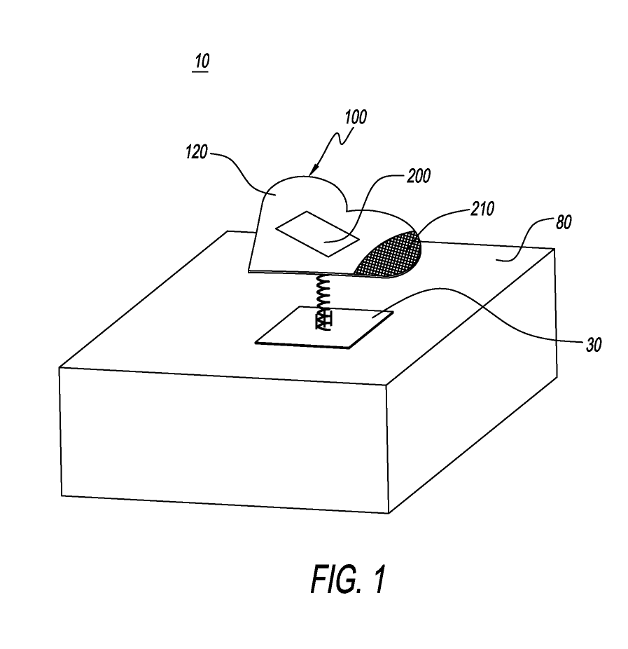

Referring to FIG. 1, shown are a support device 10, a first support element 20, a second surface 40, an elongated holder 50, which is shown as a spring 150, a first end 60, a second end 70, an external support surface 80, a second support element 100, a first surface 110, a second surface 120, and an adhering surface 190. The first support element 20 is a substantially thin and wide platform of any geometric shape, and supports the elongated holder 50, likely a spring 150, and second support 100. The first support element 20 further has a first surface 30 (FIG. 3) and a second surface 40. The first surface 30 (FIG. 3) is mounted on or attaches to an external support surface 80. The external support surface 80 may be a refrigerator door or any other metallic or non-metallic upright surface, and could be a flat surface or attachable surface. The external support surface 80 may be curved, slanted or flat. The first surface 30 may be plain or textured, with or without and adhering surface 190. If the first surface 30 does not have an adhering surface 190, it may be attached to external surface 80 with tape or glue supplied by the user. In the alternative, the first surface 30 may have an adhering surface 190. Adhering surface 190 may be one or more magnets, an adhesive or a double sided tape, foam tape, Velcro or one or more suction cups. The second support element 100 is embodied in a geometric shape, in particular in the shape of a heart.

Also shown in FIG. 1 is a second support element 100. The second support element is the decoration. The second support element 100 contains a first surface 110 and a second surface 120. The first surface 110 preferably attaches to a second end 70 of an elongated holder 50. The second surface 120 may contain a message, image or a logo. Alternatively, the second surface 120 may also be utilized as a mount point for the second end 70, or the first end 60. The second support element 100 may be embodied in a symbolic or geometric shape, for example in shape of a heart, a bobble head, a smiley, a photo or any other shape as illustrated in FIG. 3. Additional features could included glow in the dark materials or coating, fragrance emitting, and motion activation, i.e., responds with voice prompt on direct movement of the device or motion around it, i.e. “How are you doing?” when someone walks past. The second support element could also be a three dimensional feature such as a ball or foot.

In another embodiment, the second support element 100 may be capable of lighting up or may be contain with a miniature a noise emitting device 210 that plays as song or saying, popularly used in gift cards. The miniature noise emitting device could be recordable by the giver. The second support element 100 may be any two dimensional or three dimensional shapes. It may have one or more layers of the same or different materials. The second surface 120 may be plastic, and have a second layer of paper glued thereon. The paper could have a decorative design, with photos, printing, slogans, and the like. It could be writable, allowing the giver of the gift to write a personalized message, the second element 120 may come preprinted or maybe customizable by the giver or receiver. It may have accents, such as glitter, bows or other party accents.

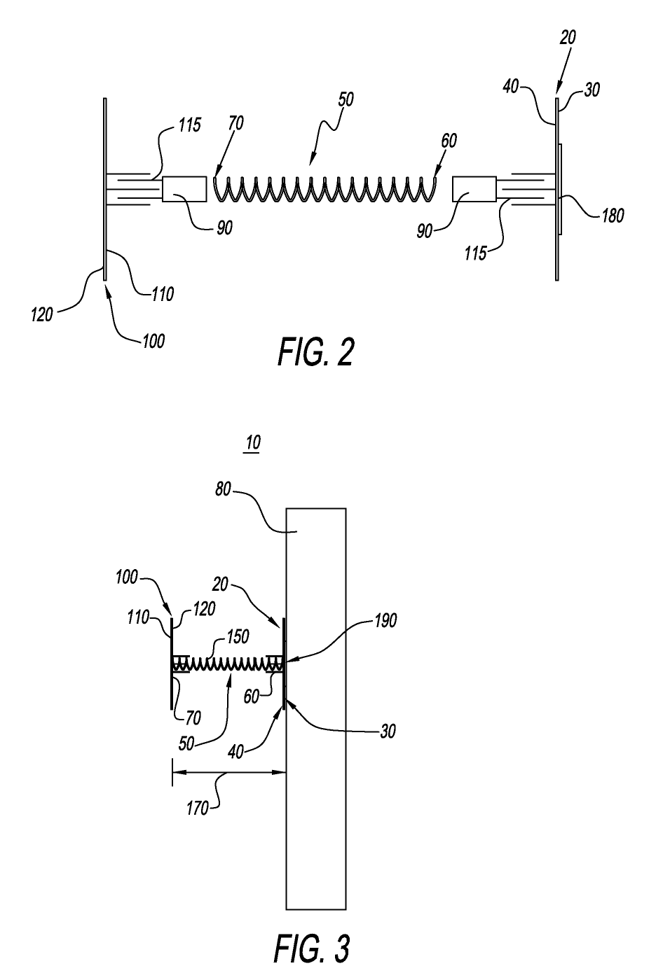

FIG. 2 is an exploded diagram of the present invention. Shown are a support device 10, a first support element 20, a first surface 30, a second surface 40, an elongated holder 50, a first end 60, a second end 70, a tubing element 90, a second support element 100, a first surface 110, a second surface 120, a magnet 180, and pins 115. The elongated holder 50 preferably contains at least one tube element 90. The tube element 90 is preferably a tube that encases the elongated holder 50 and covers one or both first end 60 and second end 70, along with one or both pins 115. The tube element 90 controls the degree to which the elongated holder 50 may flex. The tube element 90 may also be made from a metal or plastic material with a deformable memory. The tube is preferably a soft plastic tube, but may be hard plastic or other material. FIG. 2 illustrates that the elongated holder is attached to first and second support elements 20 and 100 in a detachable association, meaning that these components may be freely assembled and disassembled.

The preferred embodiment of the present invention contains a tube element 90 on each end of the elongated holder 50. The two tube elements 90 may be of equal or unequal length. Preferably each tube element 90 covers approximately fifteen to twenty five percent of the length of the elongated holder 50, with a middle section of the elongated support 50 left uncovered. In such a configuration, the tube elements 90 guard against ruinous deformation of the spring 150, while still permit the highly desirable rapid agitation or jiggling by the elongated holder 50.

The elongated holder 50 is preferably a spring 150 as shown in FIG. 2, but may be an elastic rod, or could be a telescoping rod or a fixed rod which may or may not be flexible. The preferred method of attaching the elongated holder 50 to each of the support elements 30 and 100 is by skewering its first and second ends 60 and 70 onto the pins 115. The pin 115 may be cylindrical in shape or cone shaped, with wider section of the cone on the bottom. The ends 60 and/or 70 may alternatively be pushed over pins 115, flexibly linking first support element 70 and second support element 100. Pins 115 can have a smooth surface or a textured surface or a threaded surface. The elongated holder 50 is preferably secured to the ends by friction alone, but could be glued on or welded on. Pins 115 could also be formed with hook shaped or barbed portions to secure elongated holder ends 60 and 70. Other forms of attachment may be with a fastener, welding, soldering crimping or riveting. The attachments may be permanent or detachable. Alternatively, the second surface 40 or the first surface 110 may contain an indentation into which the elongated holder 50 may be inserted. The elongated holder 50 is preferably flexible so as to illicit the highly desirable jiggling effect of the second support element 100.

FIG. 3 is a side view of the invention. Shown are a support device 10, a first support element 20, a first surface 30, a second surface 40, an elongated holder 50, a first end 60, a second end 70, a tubing element 90, a second support element 100, a first surface 110, a second surface 120, an adhesive surface 190, and pins 115. The elongated holder 50 preferably contains at least one tube element 90.

The first surface 30 may contain a combination of attachment means, for example an adhesive strip of material 190 may cover a magnetic surface 180 (FIG. 2). If a magnetic adhesion is desired or is more suitable, the adhesive strip may be peeled off to reveal the magnetic surface. The magnetic or adhesive surfaces may be separately mounted components or may be integrated into the surface of the first support element 20. The first and second surfaces 30 and 40 may be used interchangeably. Preferably the second surface 40 accepts a connection from the first end 60 of the elongated holder 50. The first and second ends 60 and 70 of the elongated holder 50 may be completely reversible, and may be mounted on the first surface 30. The preferred length 170 of the elongated support element 50 is between one forth of an inch and one inch, while the preferred width of the elongated support holder 50 may be between one eighth and one half of an inch. The preferred width 175 of the second support element 110 or of the first support element 20 may be between one and four inches. The first and second support elements 20 and 100 may be of equal or different sizes. The first and second support elements 20 and 100 may individually cover an area between 2 and 15 square inches, which represents the surface area of the second surfaces 120 and 40, as well as the surface area of the first surfaces 110 and 30.

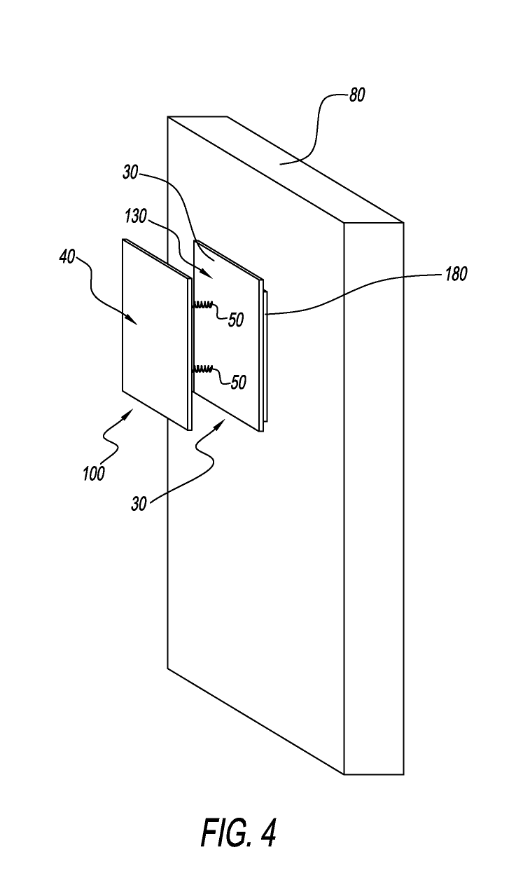

FIG. 4 is an embodiment having two elongated support holders 50. Alternatively, any number of support holders 50 may be present. FIGS. 1 and 4 demonstrate the capability of the present invention to be utilized as a cake or gift box decoration (FIG. 1) or as a fridge magnet (FIG. 4). The same device may serve both functions. For example, the article 10 may be attached to a cake box by either tying down the first support element 30 or by attaching the first support element 30 with an adhesive. Once the box is delivered, the article 10 may be removed and reattached to a supporting surface 80, such as a fridge door, by using a magnet 180.

The various parts of the present invention may be made from any material, including but not limited to: plastics and resins including but not limited to plastic, rubber, foam, silicone, ABS, Polycarbonate, Noryl™, PVC, Polystryrene, ABS/PVC, PVC/Acrylic, Polysulfone, Acrylic, Polyethylene, Kydex™, PETG; glass, including but not limited to fiberglass, borosilicate, or quartz; wood; metals; or any combinations or composites of these materials or other materials and new materials that may be manufactured in the future. The parts of the device 10 may be manufactured using identical or different materials.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A support device comprising:
a first support element, said first support element having a first surface and a second surface;
at least one elongated holder, said elongated holder having a first end and a second end;
said first end attaching to said second surface of said first support element;
said first surface of said first support element attaching to an external support surface; and
at least one tube element, said tube element mounted on said elongated holder.

2. The support device of claim 1, further comprising a second support element, said second support element having a first surface and a second surface, said first surface attaching to said second end of said elongated holder.

3. The support device of claim 1, wherein said first surface or said second surface comprises an area between 1 and 15 square inches.

4. The support device of claim 2, wherein said first surface or said second surface further comprises an area between 2 and 10 square inches.

5. The support device of claim 1, wherein said elongated holder is a spring, a flexible tube or a telescoping tube.

6. The support device of claim 1, further comprising a miniature display, a recorder, a speaker, or any combination thereof.

7. The support device of claim 1, wherein said elongated holder is between 0.5 and 2 inches in length.

8. The support device of claim 1, wherein said first surface of said support element has a magnet.

9. The support device of claim 1, wherein said first surface of said first support element has an adhesive surface.

10. The support device of claim 1, wherein said tube element is a tube that partially covers said elongated holder.

11. The support device of claim 2, wherein said second support element is mated in a detachable association with said elongated holder.

12. The support device of claim 1, wherein said elongated holder is mated in a detachable association with said first support element.

13. The support device of claim 1, having at least 2 elongated holders.

14. A support device comprising:
a first support element, said first support element having a first surface and a second surface;
a second support element, said second support element having a first surface and a second surface;
said first support element and said second support element having at least one mounting pin;
at least one elongated holder, said elongated holder having a first end and a second end;
said first end attaching to said pin on said second surface of said first support element;
said first surface of said first support element capable of attaching to an external support surface;
at least one tube element, said tube element mounted on said elongated holder; and
said tube element capable of controlling flexibility of said elongated holder.

15. The support device of claim 14, wherein said first surface or said second surface comprises an area between 2 and 10 inches.

16. The support device of claim 14, wherein said elongated holder is between 0.5 and 2 inches in length.

17. The support device of claim 14, wherein said second support element is mated in a detachable association with said elongated holder, and wherein said elongated holder said is mated in a detachable association with said first support element.
